(19) United States
(12) Patent Application Publication
(10) Pub. No.: US 2023/0173996 A1
(43) Pub. Date: Jun. 8, 2023

(54) Camera Wing System, Vehicle Therewith and Method to Operate the Same

(71) Applicant: Motherson Innovations Company Limited, London (GB)

(72) Inventors: Romeo Wieczorek, Stuttgart (DE); Matthias Koller, Stuttgart (DE)

(21) Appl. No.: 17/983,565

(22) Filed: Nov. 9, 2022

(30) Foreign Application Priority Data
Dec. 2, 2021 (DE) 102021131824.6

(51) Int. Cl. B60R 11/04; B60R 1/12

(52) U.S. Cl. CPC B60R 11/04; B60R 1/12; B60R 2001/1253

(57) ABSTRACT

A camera wing system to a vehicle comprising such camera wing system and a method to operate such a camera wing system comprising at least one camera to record a scenery in a field of view of the camera and an illuminating system to emit light to illuminate the field of view of the camera, the camera being sensitive to the light emitted by the illumination system, wherein the illuminating system provides light to the scenery in one or more emission cones (EC), where the one or more emission cones are adaptable in emission direction (ED1, ED2) and/or cone angle (CA) depending on the driving situation (DS) of the vehicle in order to illuminate the scenery in the field of view being of interest for a driver due to the detected driving situation.

### CROSS-REFERENCE TO RELATED APPLICATION

This application claims priority to German Application No. DE 10 2021 131 824.6, filed on Dec. 2, 2021, the entirety of which is incorporated herein by reference.

### FIELD OF THE INVENTION

The invention relates to a camera wing system able to illuminate the scenery in the field of view being of interest for a driver depending on the driving situation of the vehicle. The invention further relates to a vehicle comprising such camera wing system and a method to operate such a camera wing system.

### BACKGROUND OF THE INVENTION

Motor vehicles are usually equipped with exterior mirrors on both sides in the driver’s field of view, which detect the surrounding of the motor vehicle in a rear-view direction. Mirror systems consisting of several mirrors have the disadvantage that they must be adjusted carefully not to generate non-visible zones between the provided rear views of each mirror leading to an inadequately fulfilled mirror purpose. Therefore, common mirror systems are replaced by rear view camera systems recording the surrounding of the vehicle. The camera system records image data with image sensors or pixelated imaging arrays and feed the image data to a control unit for processing the image data. The processed rear-view image is displayed on at least one monitor as a screen in the field of vision of a driver.

US 8,908,040 B2 discloses an imaging system for a vehicle includes an imaging sensor having four photosensing pixels of a sub-array, with one of (a) a red-light transmitting spectral filter disposed at a first photosensing pixel whereby the first pixel of each sub-array primarily senses red visible light and with an IR transmitting spectral filter disposed at the fourth photosensing pixel whereby the fourth pixel of each sub-array primarily senses infrared radiation, and (b) a red-light transmitting spectral filter disposed at a first photosensing pixel whereby the first pixel of each sub-array primarily senses red visible light and with an IR transmitting spectral filter disposed at a third photosensing pixel whereby the third pixel of each sub-array primarily senses infrared radiation. An image processor processes the output of each sub-array to determine at least one of an infrared component of the imaged scene and a visible light component of the imaged scene. However, to operate camera systems even at night, a light source to illuminate the scenery to be observed by the camera is required. IR lighting is the commonly used light source for illumination purposes.

In case of emitting light in the visible and near infrared range to the rear, the human eye-safety range is violated easily, especially if the viewing angle behind the vehicle is extremely wide or has to go too far back. The human eye-safety range limits the acceptable emitting power of the light for these purposes. On the other hand, the more to be illuminated, the larger the lighting systems become. Considering the eye-safety requirements, no IR light source can cover the entire relevant field of view in which the trailer could move during cornering. The required aperture angle of the IR light source depends on the length of the trailer and the bending angle between the cockpit and the trailer. Considering the eye-safety requirement, no infrared light source can cover the entire area of the surroundings of a vehicle with a trailer when it is in a cornering maneuver.

It would be desirable to provide a solution to the disadvantages of the prior art, especially a solution enabling illumination of a scenery in the field of view being of interest for a driver for different driving situation of the vehicle.

### SUMMARY OF THE INVENTION

It is an object of the invention to provide a rear-view camera system solving at least some of the disadvantages of the prior art, especially a system enabling illumination of a scenery in the field of view being of interest for a driver for different driving situation of the vehicle.

This problem is solved by a camera wing system for a vehicle comprising at least one camera to record a scenery in a field of view of the camera and an illuminating system to emit light to illuminate the field of view of the camera, the camera being sensitive to the light emitted by the illumination system, wherein the illuminating system provides light to the scenery in one or more emission cones, where the one or more emission cones are adaptable in emission direction and/or cone angle depending on the driving situation of the vehicle in order to illuminate the scenery in the field of view being of interest for a driver due to the detected driving situation.

The term “camera wing system” denotes the component arranged at the side of the vehicle at a position suitable to record at least the rear view from the vehicle. The position of the camera wing system might be the same as for conventional vehicle mirror systems. Due to the possibility to display the recorded scenery inside the vehicle on a display, the camera wing system might be arranged at a position outside the field of view of the driver of the vehicle. The wing system comprises an arm or wing on which the camera is installed so that the camera is positioned over the wing somewhat away from the chassis of the vehicle so that the chassis of the vehicle cannot restrict the field of view of the camera, or can only partially restrict the field of view of the camera

The term “vehicle” denotes any motor driven vehicle driven be a driver, where the driver requires information about persons, other vehicles or objects in the near surrounding of the vehicle to be able to drive safety. As an example, motor vehicles are cars or trucks, especially when pulling trailers. The term “driving situation” denotes the direction, in which the vehicle is currently driven. The common driving situation is driving straight ahead, while cornering is a different driving situation. Other driving situations include reversing, parking, or turning. The latter can be a special form of cornering. Depending on the driving situation, the requirements for the illumination system change due to changing sceneries of interest to be observed by the driver via the camera wing system.

The term “camera” denotes any device capable of recording or recognizing the environment of a vehicle and of displaying this recognized or recorded environment in an image so that a driver can process the environment as driving information based on the image display. The camera might be an infrared (IR) camera. IR cameras will increase the visibility of objects during nighttime. Especially CCD or CMOS cameras can detect near infrared (NIR) wavelengths not detectable be the human eye. The NIR denotes light with wavelengths within a spectral range between 700 nm and 1400 nm. NIR can rely on the sun’s invisible infrared (IR) radiation during daytime operation. During nighttime operation, the NIR light may be provided by IR light sources of the illumination system illuminating the scenery in the field of view, where the reflected light is recorded by the camera. To be able to be used during nighttime, the camera must be sensitive at least to a part of the spectrum of the light emitted by the light sources of the illuminating system.

The term “field of view” denotes the extent of the observable world that is “seen” (recorded) at any given moment by the camera. The field of view relates to an angular field of view specified in degrees in vertical and horizontal direction. The recorded field of view can be displayed to the driver by camera wing system on a corresponding display connected to the camera wing system. In some embodiment the display might be part of the camera wing system. The field of view is directed to the areas of interest for the driver to be able to drive the vehicle safety without endangering other persons, objects, or vehicles in the field of view, or damaging the own vehicle. The areas of interest might by the rear and side views of the vehicle, preferably on both sides of the vehicle as well as front views.

The term “scenery” denotes the observable world, which can be seen by the driver when using the camera wing system. The scenery might be only a part of the observable world in the field of view. In daytime operation, the overall brightness might be enough to observe the complete observable world in the field of view of the camera. In nighttime operation the scenery might be restricted to the parts of the observable world, which are illuminated by the illumination system. Objects not being illuminated might be not recorded by the camera due to the too low level of light being reflected from these “dark” objects.

The term “illuminating system” denotes any system suitable to emit light of a certain wavelength spectrum of a certain intensity in a certain direction. The illumination system comprises light sources and optical components to shape the emitted light beam to reliable illuminate the scenery to be observed in the field of view of the camera. The illumination system comprises at least one light source. In other embodiments multiple light sources are arranged within the illumination system to be able to illuminate objects in different directions. The one light source or the multiple light sources might be established by an array of light sources providing one combined light source, which combined light is shaped by optical components.

For active lighting of the scenery during nighttime, objects at 20 m distance or more become visible by using an array of five LEDs as the light sources in the illumination system to illuminate the objects. However, the illumination system must fulfill the requirements for human eye safety conditions. In case of using LEDs as light sources in the illuminating system, an illuminated scenery at a distance of less than 5 m should be illuminated by an LED power of less than 100 mW. Up to 500 mW can be applied for distances between 5 m and 10 m. 2 W can be applied for distances between 15 m and 20 m. For more than 25 m, there is no special restriction for the power of the LEDs resulting from the human eye safety condition.

The term “emission cone” denotes the divergent light beam that emitted from the illumination system. The shape of the emission cone depends on the applied optical beam shaping elements. The emission cone may have of conical shape in one embodiment, while in other embodiments the geometrical shape of the light beam might be different. The term “cone angel” denotes the aperture angle of the light beam at least in one axis (horizontal or vertical). Here, the aperture angles in horizontal and vertical direction can be the same or different, which depends on the related optics in the illumination system. The emission direction denotes the direction, in which a maximum of light intensity within the emission cone is emitted.

The prior art only discloses the switching operation between normal color image and low light monochrome image which is done in an imager de-mosaicing unit but does not consider camera systems adaptable for different trailer lengths and different required viewing angles.

The camera wing system according to the present invention enables illumination of a scenery in the field of view being of interest for a driver for different driving situation of the vehicle.

In an embodiment at least one of the light sources, preferably all light sources, is an infrared light source, preferably an infrared LED or an array of infrared LEDs. Here, the near infrared (NIR) spectrum with wavelengths between 780 nm and 1400 nm is preferable, because several commonly used light sources are available for NIR. Many materials transparent in the NIR are available to manufacture the camera wing system with the illumination system inside. Cameras with conventional silicone chips (CCD or CMOS) are available. The reflection behavior of many material (objects) is at least very similar in NIR and the spectrum range visible for human eyes enabling to illuminate a scenery at nighttime with a NIR based illumination system while still be able to provide a realistic picture of the scenery to the driver obtained by the recorded NIR light reflected from the objects being illuminated. Furthermore, the degree of reflection of black clothes is much higher with NIR light resulting in a better recognition of “black” objects during nighttime. Also, vegetation is brighter in NIR compared to visible light. As a further advantage, NIR wavelengths passes through fog, haze, and rain.

In another embodiment the camera wing system comprises a swiveling unit to swivel at least a part of the optical system in order to adapt emission direction and/or cone angle of the one or more emission cones of the optical system. This allows the emission cone to be swiveled in one direction or the other depending on the driving situation in order to illuminate different sceneries with the illumination system. Here, only a single optical system with a light source, for example an array of LEDs, is needed, which are mounted together on a surface to be moved.

In another embodiment the swiveling unit comprises a base plate, a mechanical repulling unit and a controllable counteracting unit, where the repulling unit and counteracting unit are suitably connected to the to be swiveled part of the optical system to swivel at least a part of the optical system along a swivel axis or swivel point. This simple mechanical construction enables fast and reliable swiveling of the emission cone into the desired direction. In a preferred embodiment the repulling unit is a spring and the counteracting unit is an electromagnet acting on a corresponding permanent magnet arranged on the to-be-swiveled part of the optical system. In an alternative embodiment the swiveling unit is arranged as an antagonistic system enabling swiveling between two stable positions. For example, shape memory materials, or mechanical spring constructs with two end positions can be used for this purpose. The shape memory materials can be easily controlled electrically and do not require any complex mechanical construction.

In another embodiment the illuminating system comprises multiple optical systems suitably adapted to emit emission cones of different emission directions and/or cone angles for the different optical systems. Applying multiple optical system preferably aligned into different emission directions allows adapting emission direction and/or cone angle of the emission cones depending on the driving situation of the vehicle to illuminate the scenery in the field of view being of interest for a driver without mechanically movable parts. However, multiple optical systems are required. Here, the adaptation is achieved by switching off the non-desired optical systems and switching on the optical system suitable for the current driving situation. Therefore, the camera wing system is adapted to switch on and/or off a suited selection of the multiple optical systems depending on the driving situation of the vehicle. The multiple optical system can be arranged in the camera wing system in a linear arrangements side by side or as an array of optical systems.

In another embodiment one or more of the optical systems comprise at least one beam shaping element as switchable beam shaping element enabling to modify emission direction and/or cone angle of the light emitted through the switchable beam shaping element. A switchable beam shaping element enlarges the possible variation range for the emission direction to cover a wider scenery, which can be illuminated on demand. Switchable beam shaping elements are known to skilled people. They may comprise two or more light sources arranged at different positions within the optical system. In case of provided beam shaping elements, the beam shaping elements might be illuminated from light sources at different positions resulting in different emission cones. In case of further switchable beam shaping elements, the possible variation of the shape of the emission cone and the emission direction might be even broader. Beam shaping elements constructed as a hybrid technology use combinations of reflectors and lens, allowing the beam path to be altered by changing the lenses and/or the reflector.

In another embodiment the beam shaping element is arranged in a wing of the camera wing system with a first wing surface directing towards the scenery in a field of view of the camera, where at least a part of the beam shaping element establish a part of the first wing surface. In this case, camera wing systems can be provided with a good aesthetic appearance. Injection-molded curvatures of an IR-transmissive material can be placed in the first wing surface to meet both the optical and aesthetic requirements of the camera wing system. In this case, the injected material can be a two-component injection molding, or the bulge can be made of a single material. These bulges may be round perpendicular to the direction of emission, for example, approximately 38 mm in diameter with a thickness in the direction of the beam of approximately 5.5 mm. In case of multiple optical system, multiple curvatures can be present.

In another embodiment the camera wing system also comprises one or more optical system suitably arranged and equipped to emit at least one emission cone to the front of the vehicle. The measures and embodiments explained above can also be used for the illumination of the front area around the vehicle. The front area here include the direct frontal direction and the lateral forward direction.

In another embodiment the beam shaping element comprises one or more switchable lenses in order to adapt cone angle of the emission cones. Switchable lenses can be operated electrically which avoids mechanical parts to be moved enabling an optical system with reduced size.

In another embodiment the camera comprises a switchable light filter for day and night operation. This filter is preferably an IR filter. IR filters for daylight mode are advantageous since the visible ambient light is sufficient during daytime. During nighttime IR filters should be switched off or removed from the field of view in order to record a maximum of reflected light with the camera. Switchable filters enable using the same camera for daytime and nighttime operation.

In another embodiment the camera wing system comprises a control unit to control the illuminating system in order to adapt emission direction and/or cone angle of the one or more emission cones emitted by the illuminating system in response to the driving situation of the vehicle detected by a driving situation detection system of the vehicle.

The invention also relates to a vehicle comprising at least one camera wing system according to the present invention in order to cover the entire area of the surroundings of a vehicle with a trailer when it is in a cornering maneuver.

In an embodiment the vehicle further comprises a driving situation detection system in order to adapt one or more emission cones emitted by an illumination system of the camera wing system in emission direction and/or cone angle depending on the detected driving situation of the vehicle to illuminate the scenery in the field of view being of interest for a driver due to the detected driving situation. The driving detection system can, for example, measure the edge position or the wheel angle for possible cornering. It could determine the speed, as different speeds have different lighting requirements for the illumination system. It could measure the articulation angle between the tractor and trailer to determine the degree of cornering. Other measurement parameters such as road surface condition, lane keeping, lane changes and blind spot and rear obstacle impact to determine the driving situation could also be determined.

The invention also relates to a method to operate a camera wing system according to the present invention mounted on a vehicle comprising an illumination system and at least one camera being sensitive to light emitted by the illumination system, comprising following steps:
illuminating a scenery in a field of view of the camera by the light emitted in one or more emission cones by the illuminating system;
recording the illuminated scenery by the camera;
detecting the driving situation of the vehicle by a driving situation detection system; and
adapting emission direction and/or cone angle of the emission cones depending on the driving situation of the vehicle to illuminate the scenery in the field of view being of interest for a driver due to the detected driving situation.

The method according to the present invention allows to cover the entire area of the surroundings of a vehicle with a trailer by the camera wing system when the vehicle is in a cornering maneuver. Also, other driving situation are covered by the method.

The above listed embodiments can be used individually or in any combination to provide the device and the process in accordance with the invention.

### BRIEF DESCRIPTION OF THE DRAWINGS

These and other aspects of the invention are shown in detail in the illustrations as follows.

FIG. 1: a schematic illustration of one embodiment of the camera wing system according to the present invention in a top view;

FIG. 2: an enlarged view of the optical system arranged on the swiveling unit of the camera wing system as shown in FIG. 1;

FIG. 3: a schematic illustration of another embodiment of the camera wing system according to the present invention in a top view;

FIG. 4: a schematic illustration of the method to operate the camera wing system according to the present invention; and

FIG. 5: a schematic illustration of a vehicle according to the present invention, where the camera wing system is adapted to the detected driving situation for (a) straight driving and (b) driving around a curve.

### DETAILED DESCRIPTION OF EMBODIMENTS

FIG. 1 shows a schematic illustration of one embodiment of the camera wing system 1 according to the present invention in a top view comprising a camera 2 to record a scenery in a field of view FOV of the camera 2 and an illuminating system 3 to emit light to illuminate the field of view FOV of the camera 2. The camera 2 comprises a switchable light filter 21, preferably an infrared (IR) filter in order to be able for daytime and nighttime operation, and camera recording unit 22, e.g. a CCD or CMOS chip. The camera is sensitive to the light emitted by the illumination system 3. The illuminating system 3 provides light to the scenery in one emission cone EC, where the emission cone EC is adaptable in emission direction ED1, ED2 depending on the driving situation DS of the vehicle 10 to illuminate the scenery in the field of view FOV being of interest for a driver due to the detected driving situation DS. In case of the beam shaping element 33 comprises one or more switchable lenses the cone angle CA of the emission cone EC can also be adapted. The illuminating system 3 comprises at least one optical system 31 comprising one or more light sources 32 and suitable beam shaping elements 33 to define one or more emission cones EC per optical system 31. Here, the shown one light source 32 might be replaced by multiple light sources 32 in other embodiments. The light source 32 is an infrared LED or an array of infrared LEDs. The camera wing system 1 further comprising a control unit 5 to control the illuminating system to adapt emission direction ED1, ED2 and/or cone angle CA of the one or more emission cones EC emitted by the illuminating system 3 in response to the driving situation DS of the vehicle 10 detected by a driving situation detection system 20 of the vehicle 10. The beam shaping element 33 is arranged in a wing 4 of the camera wing system 1 with a first wing surface 41 directing towards the scenery in a field of view FOV of the camera 2, where at least a part of the beam shaping element 33 establish a part of the first wing surface 41.

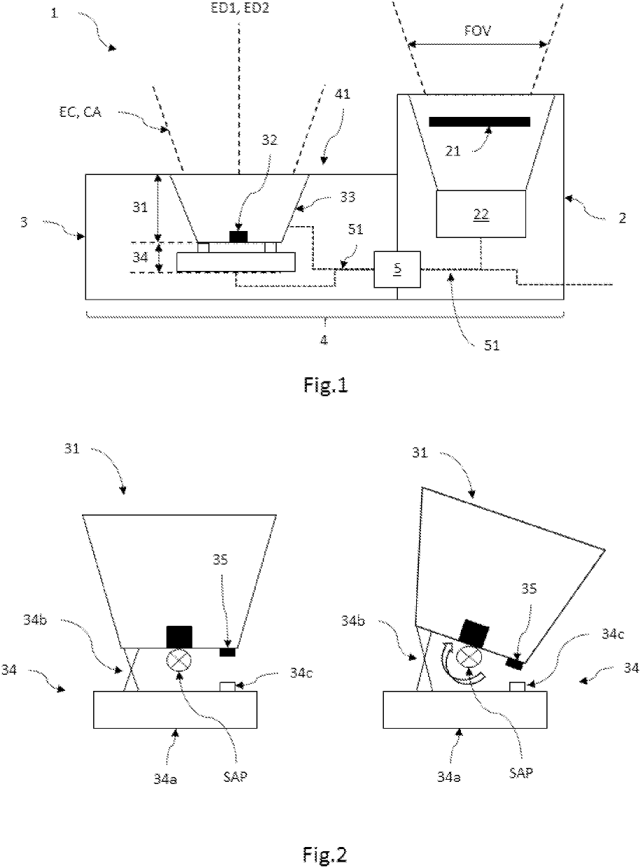

FIG. 2 shows an enlarged view of the optical system 31 arranged on the swiveling unit 34 of the camera wing system 1 as shown in FIG. 1 to swivel the optical system 32 to adapt emission direction ED1, ED2 of the mission cone EC of the optical system 3. The swiveling unit 34 comprises a base plate 34a, a mechanical repulling unit 34b and a controllable counteracting unit 34c, where the repulling unit 34b and counteracting unit 34c are suitably connected to the to be swiveled optical system 32 to swivel the optical system 32 along a swivel axis or swivel point SAP. Here, the repulling unit 34b is a spring and the counteracting unit 34c is an electromagnet acting on a corresponding permanent magnet 35 arranged on the to-be-swiveled part of the optical system 32. In other embodiments the swiveling unit 34 is arranged as an antagonistic system enabling swiveling between two stable positions.

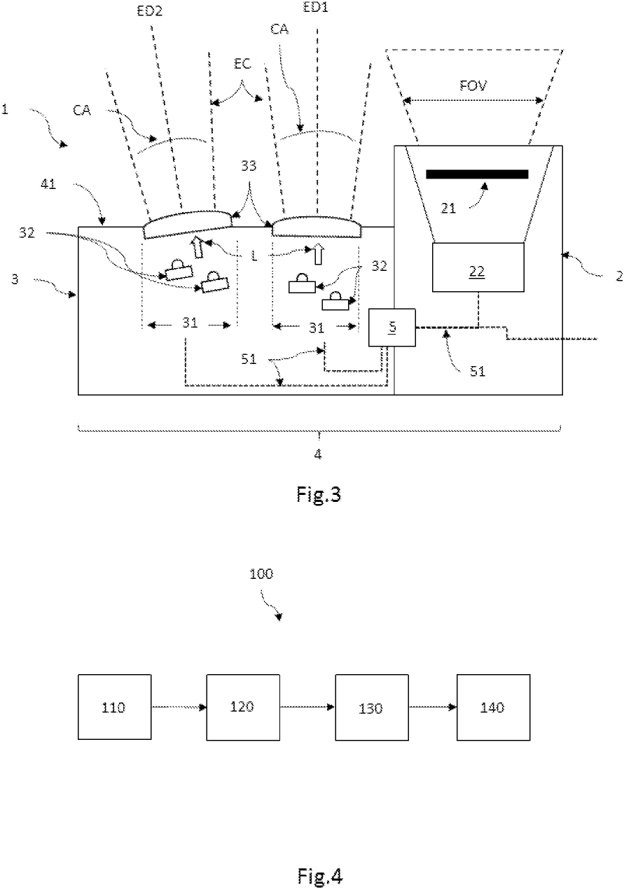

FIG. 3 shows a schematic illustration of another embodiment of the camera wing system 1 according to the present invention in a top view. For details not described with respect to FIG. 3 we refer to the details of FIG. 1. In this case the illuminating system 3 comprises two separate optical system 31 comprising two light sources 32 each and corresponding suitable beam shaping elements 33 to define one or more emission cones EC per optical system 31. The two optical systems 32 are suitably arranged to emit emission cones EC of different emission directions ED1, ED2 for the different optical systems 32. In case of the beam shaping element 33 comprising a switchable lens adapting the cone angle CA of the emission cones EC is also possible. The camera wing system 1 is adapted to switch on and/or off the two optical systems 32 depending on the driving situation DS of the vehicle 10. In an embodiment the optical systems 32 may comprise at least one beam shaping element 33 as switchable beam shaping element enabling to modify emission direction ED1, ED2 and/or cone angle CA of the light emitted through the switchable beam shaping element 33. Also, here the camera 2 comprises a switchable light filter 21 for day and night operation as well as a control unit 5 to control the illuminating system to adapt emission direction ED1, ED2 and/or cone angle CA of the two emission cones EC emitted by the illuminating system 3 in response to the driving situation DS of the vehicle 10 detected by a driving situation detection system 20 of the vehicle 10. The beam shaping elements 33 are arranged in a wing 4 of the camera wing system 1 with a first wing surface 41 directing towards the scenery in a field of view FOV of the camera 2, where at least a part of the beam shaping element 33 establish a part of the first wing surface 41.

FIG. 4 shows a schematic illustration of the method 100 to operate the camera wing system 1 according to the present invention mounted on a vehicle 10 comprising an illumination system 3 and at least one camera 2 being sensitive to light emitted by the illumination system 3, comprising following steps of illuminating 110 a scenery in a field of view FOV of the camera 2 by the light emitted in one or more emission cones EC by the illuminating system 3; recording 120 the illuminated scenery by the camera 2; detecting 130 the driving situation DS of the vehicle 10 by a driving situation detection system 20; and adapting 140 emission direction ED1, ED2 and/or cone angle CA of the emission cones EC depending on the driving situation DS of the vehicle 10 to illuminate the scenery in the field of view FOV being of interest for a driver due to the detected driving situation DS.

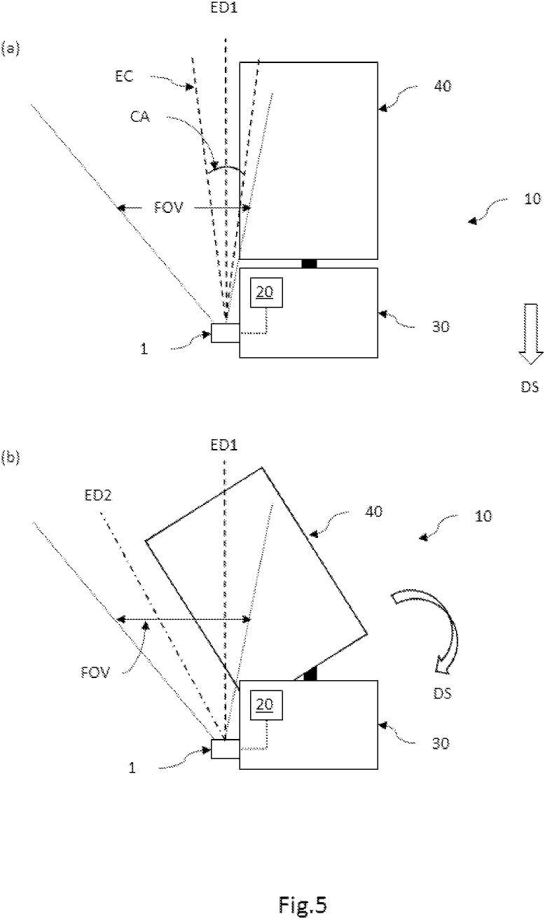

FIG. 5 shows a schematic illustration of a vehicle 10 according to the present invention comprising two camera wing systems 1, one arranged on each side of the cockpit 30 of the vehicle 10. The vehicle consists of the cockpit 30, where the driver drives the vehicle 10 and a trailer 40 rotatably mounted to the cockpit 30. For a better overview, only one of the camera wing systems 1 is shown here. The camera wing system 1 is adapted to the detected driving situation for (a) straight driving (cockpit and trailer are straight aligned) and (b) driving around a curve (cockpit and trailer have a bend angle to each other). The vehicle 10 further comprises a driving situation detection system 20 to adapt the emission cone EC with cone angle CA und first emission direction ED1 emitted by an illumination system 3 of the camera wing system 1 when driving straight into a second emission direction ED2 during driving around the curve. In this embodiment the cone angle CA is constant for both driving situations DS. As shown in FIGS. 5a and 5b the field of view FOV of the camera 2 stays constant, but the illumination system 3 changes the emission direction to the second emission direction ED2 to still illuminate the rear view of the trailer 10 even when driving the curve to illuminate the scenery in the field of view FOV being of interest for a driver when driving the curve.

The embodiments shown herein are only examples of the present invention and must therefore not be understood as being restrictive. Alternative embodiments considered by the skilled person are equally covered by the scope of protection of the present invention.

### LIST OF REFERENCE NUMERALS

1 camera wing system according to the present invention
2 camera
21 switchable light filter
22 camera recording unit
3 illuminating system
31 optical system
32 light sources, e.g. an LED or an array of LEDs, preferably emitting in the infrared spectrum
33 beam shaping elements
34 swiveling unit
34a base plate
34b (mechanically) repulling unit
34c controllable counteracting unit
35 permanent magnet
4 wing
41 first wing surface
5 control unit to control the illuminating system
51 control connection
10 vehicle according to the present invention
20 driving situation detection system
30 cockpit of the vehicle
40 trailer of the vehicle
100 method to operate a camera wing system according to the present invention
110 illuminating a scenery in a field of view of the camera
120 recording the illuminated scenery by the camera
130 detecting the driving situation of the vehicle
140 adapting emission direction and/or cone angle of the emission cones depending on the driving situation of the vehicle
CA (emission) cone angle
DS driving situation of the vehicle
EC emission cone
ED1 (first) emission direction
ED2 (second) emission direction
FOV field of view
L light emitted from the light sources of the illumination system
SAP swivel axis or swivel point

1. A camera wing system for a vehicle, comprising:
at least one camera to record a scenery in a field of view (FOV) of the camera;
an illuminating system to emit light to illuminate the FOV of the camera, the camera being sensitive to the light emitted by the illumination system,
wherein the illuminating system provides light to the scenery in one or more emission cones, where the one or more emission cones are adaptable in one or more emission direction and/or cone angle depending on a driving situation of the vehicle in order to illuminate the scenery in the FOV being of interest for a driver due to the driving situation.

2. The camera wing system according to claim 1, where the illuminating system comprises at least one optical system comprising one or more light sources and beam shaping elements to define one or more emission cones per optical system.

3. The camera wing system according to claim 2, where at least one of the light sources include an infrared light source.

4. The camera wing system according to claim 2, comprising a swiveling unit to swivel at least a part of the optical system in order to adapt the emission direction and/or cone angle of the one or more emission cones of the optical system.

5. The camera wing system according to claim 4, where the swiveling unit comprises a base plate, a mechanical repulling unit, and a controllable counteracting unit, where the repulling unit and counteracting unit are connected to the to be swiveled part of the optical system to swivel at least a part of the optical system along a swivel axis or swivel point.

6. The camera wing system according to claim 5, where the repulling unit is a spring and the counteracting unit is an electromagnet acting on a corresponding permanent magnet arranged on the to-be-swiveled part of the optical system.

7. The camera wing system according to claim 4, where the swiveling unit is arranged as an antagonistic system enabling swiveling between two stable positions.

8. The camera wing system according to claim 1, where the illuminating system comprises multiple optical systems adapted to emit emission cones of different emission directions and/or cone angles for the different optical systems.

9. The camera wing system according to claim 8, where the camera wing system is adapted to switch on or off a selection of the multiple optical systems depending on the driving situation of the vehicle.

10. The camera wing system according to claim 8, where one or more of the optical systems comprise at least one beam shaping element as a switchable beam shaping element enabling modification of the emission direction and/or cone angle of the light emitted through the switchable beam shaping element.

11. The camera wing system according to claim, where the beam shaping element is arranged in a wing of the camera wing system with a first wing surface directing towards the scenery in a field of view (FOV) of the camera, where at least a part of the beam shaping element establishes a part of the first wing surface.

12. The camera wing system according to claim 2, where the beam shaping element comprises one or more switchable lenses in order to adapt the cone angle of the emission cones.

13. The camera wing system according to claim 1, where the camera comprises a switchable light filter for day and night operation.

14. The camera wing system according to claim 1, further comprising a control unit to control the illuminating system in order to adapt the emission direction and/or cone angle of the one or more emission cones emitted by the illuminating system in response to the driving situation of the vehicle detected by a driving situation detection system of the vehicle.

15. A vehicle comprising the camera wing system of claim 1.

16. The vehicle according to claim 15, where the vehicle further comprises a driving situation detection system in order to adapt one or more emission cones emitted by an illumination system of the camera wing system in the emission direction and/or cone angle depending on the detected driving situation of the vehicle to illuminate the scenery in the field of view (FOV) being of interest for a driver due to the detected driving situation.

17. A method of operating a camera wing system mounted on a vehicle, the camera wing system comprising an illumination system and at least one camera being sensitive to light emitted by the illumination system, comprising:
illuminating a scenery in a field of view (FOV) of the camera by the light emitted in one or more emission cones by the illuminating system;
recording the illuminated scenery by the camera;
detecting a driving situation of the vehicle by a driving situation detection system; and
adapting an emission direction and/or a cone angle of the emission cones depending on the driving situation of the vehicle to illuminate the scenery in the FOV being of interest for a driver due to the driving situation.
